(19) United States
(12) Patent Application Publication
(10) Pub. No.: US 2009/0027648 A1
(43) Pub. Date: Jan. 29, 2009

(54) Method of reducing noise in an original signal, and signal processing device therefor

(75) Inventor: Marc Wilhelmus Van Der Wijst, Veldhoven (NL)

Correspondence Address: STERNE, KESSLER, GOLDSTEIN & FOX P.L.L.C., 1100 NEW YORK AVENUE, N.W., WASHINGTON, DC, 20005, US

(73) Assignee: ASML Netherlands B.V., Veldhoven (NL)

(21) Appl. No.: 11/878,630

(22) Filed: Jul. 25, 2007

(51) Int. Cl. G03B 27/58; G06F 19/00

(52) U.S. Cl. 355/72; 702/77

(57) ABSTRACT

In a method and apparatus for reducing noise in an original signal which contains a linear time varying signal and the noise, the original signal is differentiated to obtain a differentiated original signal. The differentiated original signal is Fourier transformed to obtain power spectral densities of the differentiated original signal. A noise frequency is detected in a power spectral density spectrum of the obtained power spectral densities of the differentiated original signal. For the noise frequency, a corresponding noise component is determined. The noise component is subtracted from the original signal to obtain a noise reduced original signal.

### FIELD

The present invention relates to a method of reducing noise in an original signal comprising a linear time varying signal and the noise, and to a processing device therefor. The present invention further relates to a method of reducing noise in a position signal representative of a position of an object, and to a device for measuring a position of a movable object. The present invention further relates to a method of alignment of a support of a lithographic apparatus, and to a lithographic apparatus comprising an alignment system configured to align a substrate table.

### BACKGROUND

A lithographic apparatus is a machine that applies a desired pattern onto a substrate, usually onto a target portion of the substrate. A lithographic apparatus can be used, for example, in the manufacture of integrated circuits (ICs). In such a case, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Conventional lithographic apparatus include so-called steppers, in which each target portion is irradiated by exposing an entire pattern onto the target portion at once, and so-called scanners, in which each target portion is irradiated by scanning the pattern through a radiation beam in a given direction (the “scanning”—direction) while synchronously scanning the substrate parallel or anti-parallel to this direction. It is also possible to transfer the pattern from the patterning device to the substrate by imprinting the pattern onto the substrate.

### SUMMARY

In the alignment of, for example, a substrate in a lithographic apparatus, a radiation beam generated by a radiation beam generating system, and providing a sinusoidal radiation intensity signal over time is traced, and correlated to a (normally linearly time-varying) substrate table position using a position measurement system (e.g. an interferometer system), in order to locate a marker on the substrate. The marker position is obtained by evaluating a radiation intensity curve as a function of the substrate table position, and fitting a sinusoidal function on this curve.

A problem arises if components of the radiation beam generating system undesirably vibrate, or if the substrate table position measurement signal has an undesired vibrating component, e.g. as a result of a vibrating position sensor, or if both causes of unwanted vibration play a role. Such vibration may originate from noise sources, movements of parts of the lithographic apparatus, cooling fluid flow, etc. In such a case, the radiation intensity curve is disturbed by the vibration, and the sinusoidal function may be fitted to the radiation intensity curve at a wrong position, yielding an alignment error in the lithographic apparatus. The alignment error then in fact is caused by one or more unwanted frequencies in the radiation intensity signal and/or in the substrate table position measurement signal.

Generally, a filtering of one or more unwanted frequencies from a signal usually is done by applying a low-pass filter, a high-pass filter, a band-pass filter, a notch filter, etc. However, such a filter influences the signal not only at the one or more desired (unwanted) frequencies, but also at one or more other frequencies. Thus, by filtering the signal with such a filter, the desired signal is degraded.

It is desirable, for example, to remove an unwanted frequency from a signal, in particular from a position signal, such as a position signal of a movable support of a lithographic apparatus in an alignment procedure of the lithographic apparatus, leaving the signal at other frequencies than the unwanted frequency substantially intact.

In an embodiment of the present invention, there is provided a method of reducing noise in an original signal comprising a linear time varying signal and the noise, the method comprising: differentiating the original signal to obtain a differentiated original signal; Fourier transforming the differentiated original signal to obtain power spectral densities of the differentiated original signal; detecting a noise frequency in a power spectral density spectrum of the obtained power spectral densities of the differentiated original signal; for the noise frequency, determining a corresponding noise component; and subtracting the noise component from the original signal to obtain a noise reduced original signal. An embodiment also provide a signal processing device having structure to perform such functions.

In a further embodiment of the present invention, there is provided a method of reducing noise in a position signal representative of a position of an object moving with a substantially constant velocity, the method comprising: differentiating the position signal to obtain a velocity signal; Fourier transforming the velocity signal to obtain power spectral densities of the velocity signal; detecting a noise frequency in a power spectral density spectrum of the obtained power spectral densities of the velocity signal; for the noise frequency, determining a corresponding noise component; and subtracting the noise component from the position signal to obtain a noise reduced position signal. An embodiment of the invention also provides a device for measuring a position of a movable object having structures to perform such functions, such device comprising a position sensor configured to generate a position signal representative of a position of the object while the object is moving with a substantially constant velocity.

In a further embodiment of the present invention, there is provided a method of alignment of a support of a lithographic apparatus, the method comprising: moving the support at a substantially constant velocity; generating a position signal representative of a position of the support; differentiating the position signal to obtain a velocity signal; Fourier transforming the velocity signal to obtain power spectral densities of the velocity signal; detecting a noise frequency in a power spectral density spectrum of the obtained power spectral densities of the velocity signal; for the noise frequency, determining a corresponding noise component; subtracting the noise component from the position signal to obtain a noise reduced position signal; measuring an intensity of radiation from a mark connected to the support to generate a radiation intensity measurement signal while the support is moving with the substantially constant velocity; combining the noise reduced position signal with the radiation intensity measurement signal to obtain a radiation intensity to position signal; fitting a sinusoidal curve to the radiation intensity to position signal; and aligning the support on the basis of the fitted sinusoidal curve. An embodiment of the invention also provides a lithographic apparatus comprising: a substrate table constructed to hold a substrate; an alignment system configured to align the substrate table, the alignment system having an illumination system to illuminate a mark connected to the substrate table, and a radiation intensity detection system to detect radiation from the mark, the alignment system having structure configured to perform the functions mentioned before.

In a further embodiment of the present invention, there is provided a method of alignment of a support of a lithographic apparatus, the method comprising: moving the support at a substantially constant velocity; generating a position signal representative of a position of the support; measuring an intensity of radiation from a mark connected to the support to generate a radiation intensity measurement signal while the support is moving with the substantially constant velocity; combining the position signal with the radiation intensity measurement signal to obtain a radiation intensity to position signal; weighing the radiation intensity to position signal by a Hanning window to obtain a Hanning weighed radiation intensity to position signal; fitting a sinusoidal curve to the Hanning weighed radiation intensity to position signal; and aligning the support on the basis of the fitted sinusoidal curve. An embodiment of the invention also provides a lithographic apparatus comprising: a substrate table constructed to hold a substrate; an alignment system configured to align the substrate table, the alignment system having an illumination system to illuminate a mark connected to the substrate table, and a radiation intensity detection system to detect radiation from the mark, the alignment system comprising structure configured to perform the functions mentioned before.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a curve of a position signal measured in time, where the measured position signal contains noise;

FIG. 3 depicts a curve of a velocity signal in time;

FIG. 4 depicts a power spectral density diagram of the velocity signal;

FIG. 5 depicts curves of an actual position noise signal, and a fitted position noise signal;

FIG. 6 depicts curves illustrating an application of a Hanning window to a position noise signal; and

FIG. 7 depicts a block diagram of hardware or software implemented functions in an embodiment of an apparatus or method according to the present invention.

### DETAILED DESCRIPTION

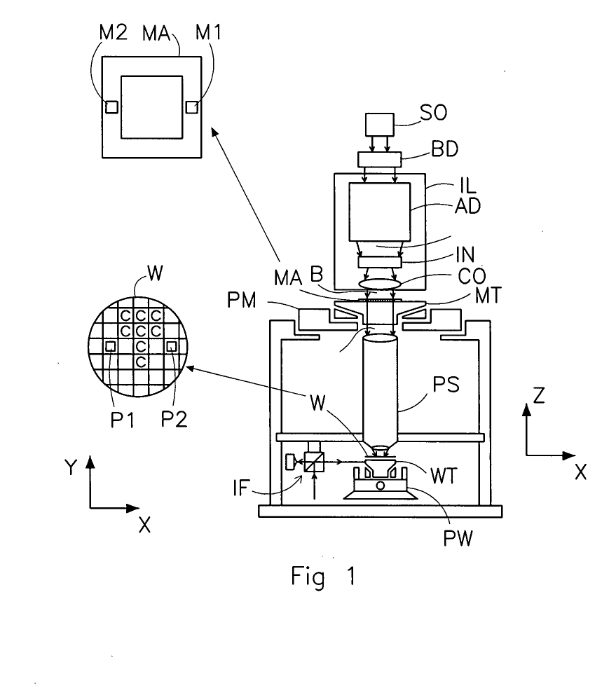

FIG. 1 schematically depicts a lithographic apparatus according to one embodiment of the invention. The apparatus includes an illumination system (illuminator) IL configured to condition a radiation beam B (e.g. UV radiation or any other suitable radiation), a patterning device support structure (e.g. a mask table) MT constructed to support a patterning device (e.g. a mask) MA and connected to a first positioning device PM configured to accurately position the patterning device in accordance with certain parameters. The apparatus also includes a substrate table (e.g. a wafer table) WT constructed to hold a substrate (e.g. a resist-coated wafer) W and connected to a second positioning device PW configured to accurately position the substrate in accordance with certain parameters. The apparatus further includes a projection system (e.g. a refractive projection lens system) PS configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, for directing, shaping, or controlling radiation.

The patterning device support structure holds the patterning device in a manner that depends on the orientation of the patterning device, the design of the lithographic apparatus, and other conditions, such as for example whether or not the patterning device is held in a vacuum environment. The patterning device support structure can use mechanical, vacuum, electrostatic or other clamping techniques to hold the patterning device. The patterning device support structure may be a frame or a table, for example, which may be fixed or movable as required. The patterning device support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section so as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more patterning device support structures). In such “multiple stage” machines the additional tables or support structure may be used in parallel, or preparatory steps may be carried out on one or more tables or support structures while one or more other tables or support structures are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques can be used to increase the numerical aperture of projection systems. The term “immersion” as used herein does not mean that a structure, such as a substrate, must be submerged in liquid, but rather only means that a liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjuster AD configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the patterning device support structure (e.g., mask table) MT, and is patterned by the patterning device. Having traversed the patterning device MA, the radiation beam B passes through the projection system PS, which focuses the beam onto a target portion C of the substrate W. With the aid of the second positioning device PW and position sensor IF (e.g. an interferometric device, linear encoder or capacitive sensor), the substrate table WT can be moved accurately, e.g. so as to position different target portions C in the path of the radiation beam B. Similarly, the first positioning device PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioning device PM. Similarly, movement of the substrate table WT may be realized using a long-stroke module and a short-stroke module, which form part of the second positioning device PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus could be used in at least one of the following modes:

1. In step mode, the support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

Before the lithographic apparatus can be used to apply a desired pattern onto a substrate, the position of the substrate W on the substrate table WT should be accurately known. The process of obtaining accurate positioning of two objects relative to each other is commonly referred to as “alignment”. For this purpose, both the substrate and the substrate table are provided with alignment marks comprising (transmission or reflection) diffraction gratings. The marks are illuminated by a beam of radiation (e.g., a laser beam), creating diffraction orders of which the intensities can be detected. In this detection, a reference detection grating is used having the same or similar grating as the grating of the alignment mark, and the intensity of the radiation orders diffracted by the alignment mark and filtered by the reference detection grating is detected by a sensor while moving the substrate table, and hence the alignment mark, relative to the sensor. At the same time, the position of the substrate table is detected, e.g. with a laser interferometer system.

The pattern of the radiation intensity of a specific diffraction order as a function of position of the substrate table, is repetitive, and essentially sinusoidally shaped. In order to obtain the exact position of the substrate table or the substrate in the alignment, a sinusoidal curve is fitted to the pattern of radiation intensities measured. Below, a curve-fitting procedure is given for a direction x. For other directions, the procedure is similar.

As stated above, during an alignment scan in the x direction, a sinusoidal signal of intensity I versus position x is measured. This signal will be fitted with the following model:

$$f ( x ) = D C + A cos ( \frac{2 π x}{p} ) + B sin ( \frac{2 π x}{p} ) \qquad ( 1 )$$

where p is the period of the order. The intensity data consists of N measurements of position xₙ and intensities Iₙ. An error function is defined depending on the fit parameters A, B and DC in equation (1):

$$ɛ = {\sum }_{n = 1}^{N} {[ {I}_{n} - f ( {x}_{n} ) ]}^{2} \qquad ( 2 )$$

The parameters A, B and DC according to equation (1) for which this error function is minimized can be determined by solving the equations:

$$\frac{d ɛ}{d A} = 0 , \frac{d ɛ}{d B} = 0 , \frac{d ɛ}{d D C} = 0 \qquad ( 3 )$$

Substituting the definition of f(x) from equation (1) provides the following set of equations:

Σ[DC+ACₙ+BSₙ−Iₙ]=0

Σ[DC+ACₙ+BSₙ−Iₙ]Cₙ=0

Σ[DC+ACₙ+BSₙ−Iₙ]Sₙ=0 (4)

with:

$${C}_{n} = Cos ( \frac{2 π {x}_{n}}{p} ) , \\ {S}_{n} = Sin ( \frac{2 π {x}_{n}}{p} ) \qquad ( 5 )$$

The above set of equations (4) can be written in the following matrix equation (6):

$$( \begin{matrix}N & U & V \\ U & X & Y \\ V & Y & S\end{matrix} ) ( \begin{matrix}D C \\ A \\ B\end{matrix} ) = ( \begin{matrix}W \\ Z \\ T\end{matrix} ) \qquad ( 6 )$$

with the following definitions for the different matrix elements of the matrix equation (6):

$$\begin{matrix}U = \sum {C}_{n} & V = \sum {S}_{n} & W = \sum {I}_{n} \\ X = \sum {C}_{n}^{2} & S = \sum {S}_{n}^{2} & R = \sum {I}_{n}^{2} \\ Y = \sum {S}_{n} {C}_{n} & Z = \sum {I}_{n} {C}_{n} & T = \sum {I}_{n} {S}_{n}\end{matrix} , \qquad ( 7 )$$

where N is the number of samples and R will be needed later when determining an MCC value (Multiple Correlation Coefficient) of the fit. From these equations, it can be seen that fitting is a two step process. During an alignment scan, the above summations must be calculated. After the alignment scan, when all summation are done, the above matrix equation (6) must be solved, applying Cramer's Rule:

$$\begin{matrix}D = \vert \begin{matrix}N & U & V \\ U & X & Y \\ V & Y & S\end{matrix} \vert , D 1 = \vert \begin{matrix}W & U & V \\ Z & X & Y \\ T & Y & S\end{matrix} \vert , \\ D 2 = \vert \begin{matrix}N & W & V \\ U & Z & Y \\ V & T & S\end{matrix} \vert , D 3 = \vert \begin{matrix}N & U & W \\ U & X & Z \\ V & Y & T\end{matrix} \vert , \\ D C = \frac{D 1}{D} , A = \frac{D 2}{D} , B = \frac{D 3}{D} .\end{matrix} \qquad ( 8 )$$

During the alignment scan, the velocity of the substrate table is kept substantially constant. Nevertheless, in the position measurement of the substrate table, a vibration may be introduced, e.g. caused by a vibrating movement of a position sensor used for measuring the position of the substrate table. Thus, a position signal from the position sensor may contain at least one noise frequency. When the distorted position signal is combined with the sinusoidal radiation intensity signal, this radiation intensity signal as a function of position will also be distorted. With certain kinds of noise, the radiation intensity signal may appear generally shifted in position compared to its actual position, resulting in an error in the fit algorithm described above by the equations (1)-(8), which may result in an alignment error, which an embodiment of the present invention seeks to reduce.

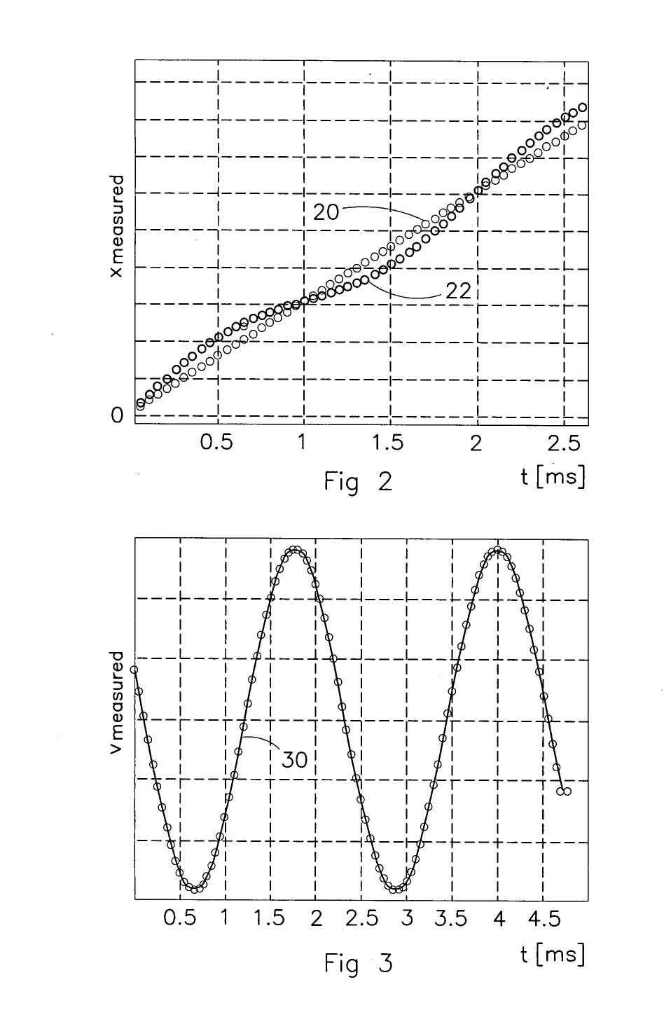

FIG. 2 illustrates a position signal in time containing noise. On the horizontal axis, time t is represented, while on the vertical axis a substrate table position x_{table} is represented. A substrate table velocity v_{table} is substantially constant which, in an ideal situation, would render a linear relationship 20 between time t and substrate table position x_{table}. However, it will be assumed that position noise xₙₒᵢₛₑ was introduced in the measurement of the substrate table, resulting in a measured position signal x_{measured} 22 containing a main noise frequency of (merely by way of example) 500 Hz. It is further noted that in the example of FIG. 2, the amplitude of the position noise xₙₒᵢₛₑ has been chosen arbitrarily. Generally:

x_{measured}=v_{table}*t+xₙₒᵢₛₑ (9)

or:

xₙₒᵢₛₑ=x_{measured}−v_{table}*t (10)

In a next step, as illustrated in FIG. 3, differentiation of relationship (9) above yields:

v_{measured}=v_{table}+vₙₒᵢₛₑ (11)

where v_{table} is substantially constant, v_{measured} is the measured velocity signal (i.e. the differentiated measured position signal x_{measured}) 30, and vₙₒᵢₛₑ is the differentiated position noise xₙₒᵢₛₑ. FIG. 3 shows the measured velocity signal v_{measured} 30 against time t.

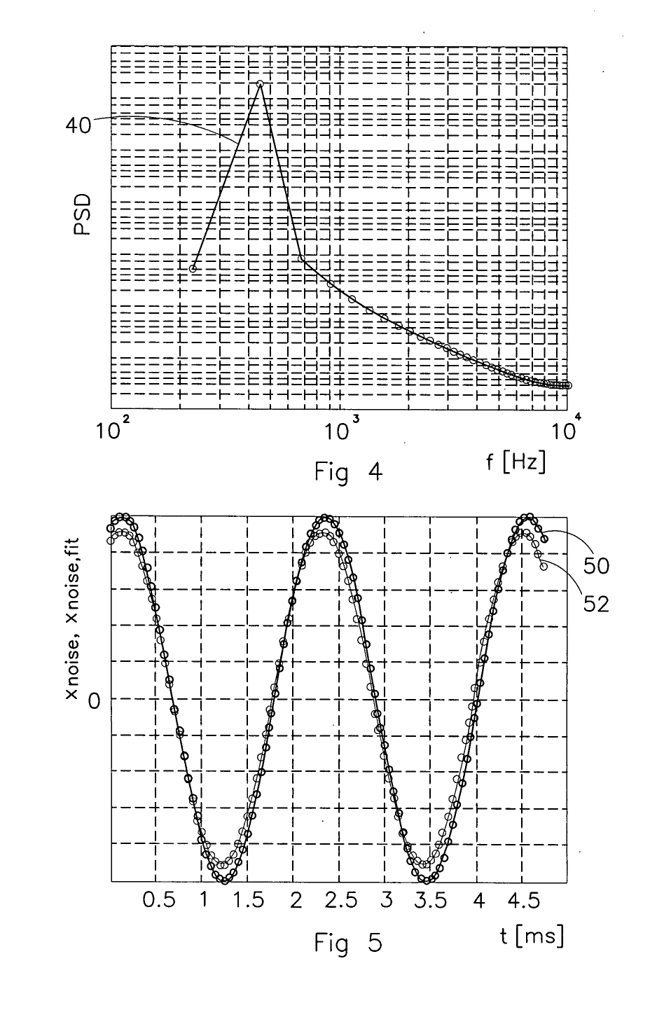

In a next step, as illustrated in FIG. 4, the measured velocity signal v_{measured} is Fourier transformed to obtain power spectral densities 40 of the measured velocity signal. FIG. 4 clearly shows a peak power spectral density at 500 Hz. From this Fourier transformation, the amplitude Aₙₒᵢₛₑ, the phase phiₙₒᵢₛₑ and the frequency fₙₒᵢₛₑ of one or more components of the position noise xₙₒᵢₛₑ may be obtained. A fitted position noise signal x_{noise,fit} is determined by:

x_{noise,fit}=Aₙₒᵢₛₑ*cos(2π*fₙₒᵢₛₑ*t+phiₙₒᵢₛₑ) (12)

In a next step, the fitted position noise signal x_{noise,fit} is subtracted from the measured position signal x_{measured}. Referring to FIG. 5, an actual position noise signal xₙₒᵢₛₑ may be represented by curve 50, while the fitted noise signal x_{noise,fit} may be represented by curve 52. It appears from FIG. 5 that the actual position noise signal xₙₒᵢₛₑ may be cancelled to a high degree (in other words: the noise may be reduced to a high degree, leaving only a small error) in a corrected measured position signal x_{measured,corrected} calculated using equation (9):

x_{measured,corrected}=x_{measured}−x_{noise,fit}=v_{table}*t+xₙₒᵢₛₑ−x_{noise,fit}=v_{table}*t+error (13)

If the fitted noise signal x_{noise,fit} would be equal to the actual position noise signal xₙₒᵢₛₑ, then by the steps discussed above the desired position signal would be obtained from the corrected measured position signal x_{measured,corrected}, and the error in relationship (13) would be equal to zero.

In a lithographic apparatus, the corrected measured position signal x_{measured,corrected} may be used to construct a radiation intensity signal as a function of substrate table position, whereafter an alignment fit may be performed which may be very accurate.

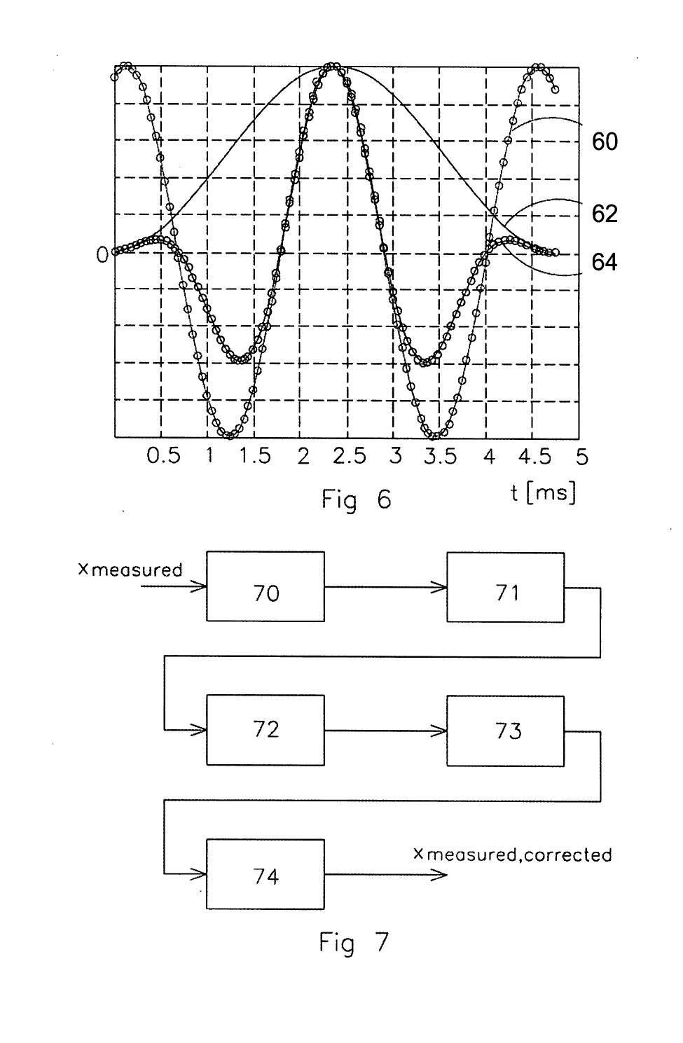

Instead of the Fourier transformation as illustrated and described above with reference to FIG. 4, a radiation intensity signal as a function of a measured position signal (containing a position noise signal) may be weighed by applying a well-known Hanning window to obtain a weighed radiation intensity signal. As illustrated in FIG. 6, a radiation intensity signal 60 is weighed with a Hanning window 62 to obtain a Hanning weighed radiation intensity signal 64.

By applying the Hanning window, the effect of the position noise signal xₙₒᵢₛₑ on the fitted radiation intensity curve may be cancelled to a considerable degree (in other words: the noise may be reduced to a considerable degree, although not as well as in the case of calculating the fitted position noise signal x_{noise,fit} previously described).

Although above an alignment scan has been taken as an application example of the present invention, an embodiment of this invention may be applied in various other fields where disturbance of a linear time varying signal needs to be reduced. An example of such an other field is measuring a height map of a substrate measured by a level sensor. Of course, other supports or objects than the substrate and substrate table can be aligned or measured, such as a patterning device and its support structure, and thus an embodiment of the invention may be applied to any other type of alignment or measurement method.

As shown in FIG. 7, the steps illustrated above with reference to FIGS. 2-5 may be performed by hardware components or software routines. FIG. 7 shows a differentiator 70 configured to differentiate a noise-distorted original (linear time varying) signal x_{measured} to obtain a differentiated original signal, a Fourier transformer 71 configured to Fourier transform the differentiated original signal to obtain power spectral densities of the differentiated original signal, a detector 72 configured to detect at least one noise frequency in a power spectral density spectrum of the obtained power spectral densities of the differentiated original signal, a noise assembler 73 configured to determine a noise component for the at least one noise frequency; and a subtractor 74 configured to subtract the noise component from the original signal to obtain a noise reduced original signal x_{measured,corrected}.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The descriptions above are intended to be illustrative, not limiting. Thus, it will be apparent to one skilled in the art that modifications may be made to the invention as described without departing from the scope of the claims set out below.

What is claimed is:

1. A method of reducing noise in an original signal comprising a linear time varying signal and the noise, the method comprising:
differentiating the original signal to obtain a differentiated original signal;
Fourier transforming the differentiated original signal to obtain power spectral densities of the differentiated original signal;
detecting a noise frequency in a power spectral density spectrum of the obtained power spectral densities of the differentiated original signal;
for the noise frequency, determining a corresponding noise component; and
subtracting the noise component from the original signal to obtain a noise reduced original signal.

2. A method of reducing noise in a position signal representative of a position of an object moving with a substantially constant velocity, the method comprising:
differentiating the position signal to obtain a velocity signal;
Fourier transforming the velocity signal to obtain power spectral densities of the velocity signal;
detecting a noise frequency in a power spectral density spectrum of the obtained power spectral densities of the velocity signal;
for the noise frequency, determining a corresponding noise component; and
subtracting the noise component from the position signal to obtain a noise reduced position signal.

3. A method of alignment of a support of a lithographic apparatus, the method comprising:
moving the support at a substantially constant velocity;
generating a position signal representative of a position of the support;
differentiating the position signal to obtain a velocity signal;
Fourier transforming the velocity signal to obtain power spectral densities of the velocity signal;
detecting a noise frequency in a power spectral density spectrum of the obtained power spectral densities of the velocity signal;
for the noise frequency, determining a corresponding noise component;
subtracting the noise component from the position signal to obtain a noise reduced position signal;
measuring an intensity of radiation from a mark connected to the support to generate a radiation intensity measurement signal while the support is moving with the substantially constant velocity;
combining the noise reduced position signal with the radiation intensity measurement signal to obtain a radiation intensity to position signal;
fitting a sinusoidal curve to the radiation intensity to position signal; and
aligning the support on the basis of the fitted sinusoidal curve.

4. A method of alignment of a support of a lithographic apparatus, the method comprising:
moving the support at a substantially constant velocity;
generating a position signal representative of a position of the support;
measuring an intensity of radiation from a mark connected to the support to generate a radiation intensity measurement signal while the support is moving with the substantially constant velocity;
combining the position signal with the radiation intensity measurement signal to obtain a radiation intensity to position signal;
weighing the radiation intensity to position signal by a Hanning window to obtain a Hanning weighed radiation intensity to position signal;
fitting a sinusoidal curve to the Hanning weighed radiation intensity to position signal; and
aligning the support on the basis of the fitted sinusoidal curve.

5. A signal processing device for reducing noise in an original signal comprising a linear time varying signal and the noise, the device comprising:
a differentiator configured to differentiate the original signal to obtain a differentiated original signal;
a Fourier transformer configured to Fourier transform the differentiated original signal to obtain power spectral densities of the differentiated original signal;
a detector configured to detect a noise frequency in a power spectral density spectrum of the obtained power spectral densities of the differentiated original signal;
a noise assembler configured to determine a noise component for the noise frequency; and
a subtractor configured to subtract the noise component from the original signal to obtain a noise reduced original signal.

6. A device for measuring a position of a movable object, the device comprising:
a position sensor configured to generate a position signal representative of a position of the object while the object is moving with a substantially constant velocity;
a differentiator configured to differentiate the position signal to obtain a velocity signal;
a Fourier transformer configured to Fourier transform the velocity signal to obtain power spectral densities of the velocity signal;
a detector configured to detect a noise frequency in a power spectral density spectrum of the obtained power spectral densities of the velocity signal;
a noise assembler configured to determine a noise component for the noise frequency; and
a subtractor configured to subtract the noise component from the position signal to obtain a noise reduced position signal.

7. A lithographic apparatus comprising:
a substrate table constructed to hold a substrate;
an alignment system configured to align the substrate table, the alignment system having an illumination system to illuminate a mark connected to the substrate table, and a radiation intensity detection system to detect radiation from the mark, the alignment system configured to:
cause the substrate table to move at a constant velocity;
generate a position signal representative of a position of the substrate table;
differentiate the position signal to obtain a velocity signal;
Fourier transform the velocity signal to obtain power spectral densities of the velocity signal;
detect a noise frequency in a power spectral density spectrum of the obtained power spectral densities of the velocity signal;
for the noise frequency, determine a corresponding noise component;
subtract the noise component from the position signal to obtain a noise reduced position signal;
measure an intensity of radiation from the mark to generate a radiation intensity measurement signal while the substrate table is moving with the substantially constant velocity;
combine the noise reduced position signal with the radiation intensity measurement signal to obtain a radiation intensity to position signal;
fit a sinusoidal curve to the radiation intensity to position signal; and
align the substrate table on the basis of the fitted sinusoidal curve.

8. A lithographic apparatus comprising:
a substrate table constructed to hold a substrate;
an alignment system configured to align the substrate table, the alignment system having an illumination system to illuminate a mark connected to the substrate table, and a radiation intensity detection system to detect radiation from the mark, the alignment system configured to:
cause the substrate table to move at a substantially constant velocity;
generate a position signal representative of a position of the substrate table;
measure an intensity of radiation from the mark to generate a radiation intensity measurement signal while the substrate table is moving with the substantially constant velocity;
combine the position signal with the radiation intensity measurement signal to obtain a radiation intensity to position signal;
weigh the radiation intensity to position signal by a Hanning window to obtain a Hanning weighed radiation intensity to position signal;
fit a sinusoidal curve to the Hanning weighed radiation intensity to position signal; and
align the substrate table on the basis of the fitted sinusoidal curve.
